(19) United States
(12) Patent Application Publication
(10) Pub. No.: US 2018/0133091 A1
(43) Pub. Date: May 17, 2018

(54) WALKING TRAINING SYSTEM

(71) Applicant: TOYOTA JIDOSHA KABUSHIKI KAISHA, Toyota-shi (JP)

(72) Inventors: Yoh SATO, Miyoshi-shi (JP); Kenta KONISHI, Toyota-shi (JP)

(73) Assignee: TOYOTA JIDOSHA KABUSHIKI KAISHA, Toyota-shi (JP)

(21) Appl. No.: 15/788,120

(22) Filed: Oct. 19, 2017

(30) Foreign Application Priority Data
Nov. 11, 2016 (JP) 2016-220690

(51) Int. Cl. A61H 3/00

(52) U.S. Cl. CPC A61H 3/00; A61H 2003/007; A61H 2203/0406; A61H 2201/12; A61H 2201/165; A61H 2201/50; A61H 2201/164

(57) ABSTRACT

The walking training system 1 includes an upper acceleration sensor 52 and a lower acceleration sensor 54 installed at locations on the walking assistance apparatus 2 spaced apart from each other in a leg length direction. The control apparatus 100 estimates an acceleration at the center of gravity of the walking assistance apparatus 2 from accelerations acquired by the upper acceleration sensor 52 and the lower acceleration sensor 54. The control apparatus 100 then calculates an inertia force acting on the walking assistance apparatus 2 from the product of the acceleration at the center of gravity and the weight of the walking assistance apparatus 2. The control apparatus 100 controls the forward pulling unit 35 and the backward pulling unit 37 to reduce the inertia force acting on the walking assistance apparatus 2.

### CROSS REFERENCE TO RELATED APPLICATIONS

This application is based upon and claims the benefit of priority from Japanese patent application No. 2016-220690, filed on Nov. 11, 2016, the disclosure of which is incorporated herein in its entirety by reference.

### BACKGROUND

The present disclosure relates to a walking training system and more particularly relates to a walking training system for a user who wears a walking assistance apparatus on his/her leg part to perform walking training.

It is known to perform training by attaching a leg attachment (a walking assistance apparatus) that assists a walking operation to a leg of a patient, who is a trainee (a user) suffering from hemiplegia when, for example, the patient performs walking training on a treadmill or the like. With regard to this technique, Japanese Unexamined Patent Application Publication No. 2015-223294 discloses a walking training apparatus for a user to perform walking training. The walking training apparatus disclosed in Japanese Unexamined Patent Application Publication No. 2015-223294 includes a walking assistance apparatus that is mounted on a leg part of the user and assists the user's walking, a first pulling means for pulling at least one of the walking assistance apparatus and the leg part of the user upward and frontward, and a second pulling means for pulling at least one of the walking assistance apparatus and the leg part of the user upward and rearward.

### SUMMARY

When the user who wears the walking assistance apparatus performs walking training, the inertia force due to the weight of the walking assistance apparatus may act on the walking assistance apparatus. Thus, it is possible that the user may not be able to efficiently perform walking training due to the influence of the inertia force. The inertia force acting on the walking assistance apparatus may be obtained by the product of the weight of the walking assistance apparatus and the acceleration at the center of gravity of the walking assistance apparatus. Accordingly, it may be possible to calculate the inertia force by installing an acceleration sensor at the center of gravity of the walking assistance apparatus and measuring the acceleration at the center of gravity and to control the pulling forces of the pulling means in such a way as to reduce the inertia force that has been calculated.

However, when an acceleration sensor cannot be installed at the center of gravity of the walking assistance apparatus due to a reason regarding the structure of the walking assistance apparatus, the aforementioned method cannot be employed. In such a case, it is impossible to calculate the inertia force acting on the walking assistance apparatus. Accordingly, there is a room for improving the efficiency of performing the walking training by sufficiently reducing the inertia force acting on the walking assistance apparatus.

The present invention provides a walking training system capable of performing walking training more efficiently regardless of the structure of the walking assistance apparatus.

A walking training system according to the present invention is a walking training system used by a user for walking training, the walking training system including: a walking assistance apparatus configured to be mounted on a leg part of the user and assist the user's walking; two acceleration sensors installed at locations on the walking assistance apparatus spaced apart from each other in a leg length direction; at least one pulling means for pulling at least one of the walking assistance apparatus and the leg part; and control means for controlling a pulling force of the pulling means, in which the control means estimates, using a distance between a predetermined location corresponding to the center of gravity on the walking assistance apparatus and locations where the two acceleration sensors are installed and accelerations in the locations where the two acceleration sensors are installed acquired by the two acceleration sensors, an acceleration at the predetermined location, and controls the pulling force to reduce an inertia force acting on the walking assistance apparatus calculated from the product of the estimated acceleration and the weight of the walking assistance apparatus.

According to the present invention, even when the acceleration sensor is not installed at the center of gravity of the walking assistance apparatus, it becomes possible to estimate the acceleration in a predetermined location corresponding to the center of gravity of the walking assistance apparatus and to control the pulling forces of the pulling means in such a way as to reduce the inertia force acting on the walking assistance apparatus calculated from the product of the acceleration that has been estimated and the weight of the walking assistance apparatus. Accordingly, according to the present invention, it is possible to reduce the inertia force acting on the walking assistance apparatus even when the acceleration sensor is not installed at the center of gravity of the walking assistance apparatus. Accordingly, according to the present invention, it is possible to perform walking training more efficiently regardless of the structure of the walking assistance apparatus.

Further, preferably, the walking assistance apparatus includes a leg length variable mechanism configured to vary the length of the walking assistance apparatus in the leg length direction, the spacing between the two acceleration sensors varying depending on the change in the length of the walking assistance apparatus in the leg length direction, and the control means acquires the distance that has been changed depending on the spacing between the two acceleration sensors that has been changed and controls the pulling force using the acquired distance.

While the change in the length of the walking assistance apparatus causes a change in the center of gravity of the walking assistance apparatus, since the present invention is configured as stated above, even when the length of the walking assistance apparatus is changed, it is possible to calculate the inertia force acting on the walking assistance apparatus. Accordingly, in the present invention, even when the length of the walking assistance apparatus is changed, it is possible to reduce the inertia force acting on the walking assistance apparatus. Accordingly, in the present invention, even when the length of the walking assistance apparatus is changed, it is possible to perform the walking training more efficiently.

Further, preferably, the pulling means includes: a first pulling means for pulling at least one of the walking assistance apparatus and the leg part of the user upward and frontward; and a second pulling means for pulling at least one of the walking assistance apparatus and the leg part of the user upward and rearward, and the control means controls the pulling force of the first pulling means and the pulling force of the second pulling means in such a way as to reduce a load of the walking assistance apparatus applied to the leg part.

The present invention is configured to perform the control for reducing the load of the walking assistance apparatus on the leg part as stated above, to thereby reduce the burden on the user due to the wear of the walking assistance apparatus during the walking training.

Further, preferably, the pulling means further includes a third pulling means for pulling at least one of the walking assistance apparatus and the leg part of the user downward, and the control means controls the pulling force of the first pulling means, the pulling force of the second pulling means, and the pulling force of the third pulling means.

Since the present invention is configured as stated above, the limitation of the direction of the synthetic vector of the pulling forces of the pulling means is suppressed. Accordingly, the present invention enables the degree of freedom of the method of reducing the burden on the user due to the wear of the walking assistance apparatus during the walking training to be increased.

Further, preferably, the control means determines a start and an end of swing of the leg part on which the walking assistance apparatus is mounted and controls the pulling force in such a way as to reduce an inertia force acting on the walking assistance apparatus for a predetermined period of time including the timing when the leg part starts the swing and a predetermined period of time including the timing when the leg part ends the swing.

Since the present invention is configured as stated above, there is no need to perform control for reducing the inertia force acting on the walking assistance apparatus in a period other than the timing when the leg part starts the swing and the timing when the leg part ends the swing, which are the timings when a large inertia force may act on the walking assistance apparatus. Accordingly, the present invention enables performance of the control for reducing the load of the walking assistance apparatus more definitely in a period other than the timing when the leg part starts the swing and the timing when the leg part ends the swing.

According to the present invention, it is possible to provide a walking training system capable of performing walking training more efficiently regardless of the structure of the walking assistance apparatus.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF DRAWINGS

FIG. 1 is a perspective view showing an external view of a walking training system according to a first embodiment;

FIG. 2 is a perspective view showing an external view of a walking assistance apparatus according to the first embodiment;

FIG. 3 is a diagram showing a schematic view of the walking training system according to the first embodiment;

FIG. 4 is a block diagram showing a hardware configuration of the walking training system according to the first embodiment;

FIG. 5 is a diagram showing the walking assistance apparatus and acceleration sensors according to the first embodiment;

FIG. 6 is a block diagram showing a configuration of a control apparatus according to the first embodiment;

FIG. 7 is a flowchart showing a walking training method performed using the walking training system according to the first embodiment;

FIG. 8 is a diagram for describing a method of calculating a wire pulling force; and

FIG. 9 is a diagram showing a walking training system according to a second embodiment.

### DESCRIPTION OF EMBODIMENTS

### First Embodiment

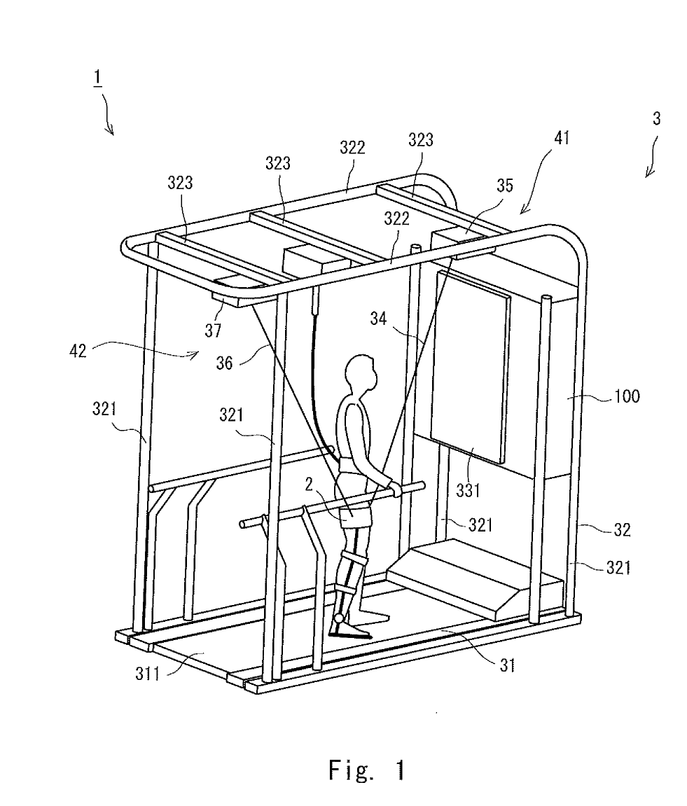

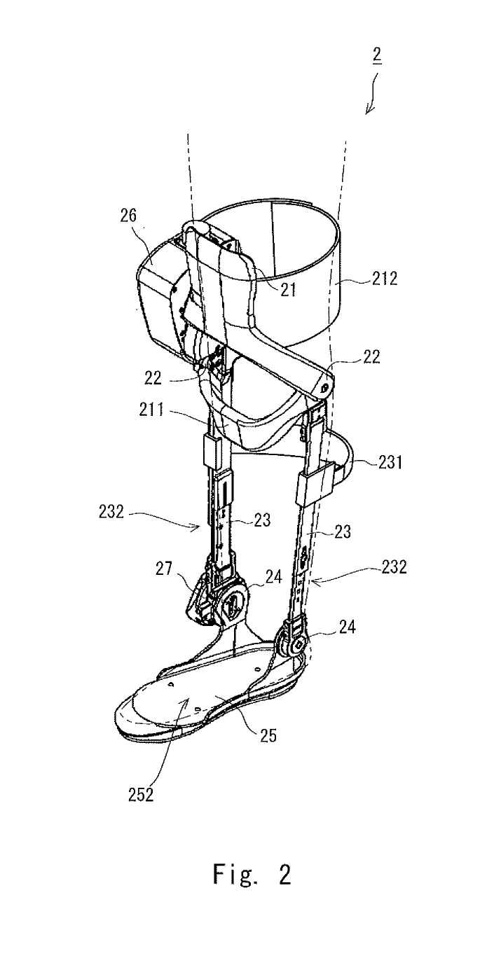

Hereinafter, with reference to the drawings, embodiments of the present disclosure will be described. FIG. 1 is a perspective view showing an external view of a walking training system 1 according to a first embodiment. FIG. 2 is a perspective view showing an external view of a walking assistance apparatus according to the first embodiment. The walking training system 1 according to this embodiment is used to perform, for example, walking training for a user such as a patient suffering from hemiplegia. The walking training system 1 includes a walking assistance apparatus 2 mounted on a leg part of the user, a training apparatus 3 which performs the walking training for the user, and a control apparatus 100.

The walking assistance apparatus 2 is mounted on, for example, an affected leg of the user who performs waling training and assists user's walking. The walking assistance apparatus 2 includes an upper thigh frame 21, a lower thigh frame 23 coupled to the upper thigh frame 21 via a knee joint part 22, a sole frame 25 coupled to the lower thigh frame 23 via an ankle joint part 24, a motor unit 26 that rotationally drives the knee joint part 22, and an adjustment mechanism 27 that adjusts a movable range of the ankle joint part 24. The structure of the walking assistance apparatus 2 is merely one example and the structure thereof is not limited to the one stated above. The walking assistance apparatus 2 may include, for example, a motor unit that rotationally drives the ankle joint part 24.

The upper thigh frame 21 is fixed to the upper thigh part of the leg part of the user and the lower thigh frame 23 is fixed to the lower thigh part of the leg part of the user. The upper thigh frame 21 is provided with, for example, an upper thigh equipment 212 to fix the upper thigh part. The upper thigh equipment 212 is fixed to the upper thigh part using, for example, magic tape (registered trademark). It is therefore possible to prevent the walking assistance apparatus 2 from being deviated in the horizontal direction or the vertical direction from the leg part of the user.

The lower thigh frame 23 is provided with a first frame 211 which is formed in a horizontal long shape and extends in the horizontal direction to connect a forward wire 34 of a forward pulling mechanism 41 (first pulling means) described later. The lower thigh frame 23 is provided with a second frame 231 which is formed in a horizontal long shape and extends in the horizontal direction to connect a backward wire 36 of a backward pulling mechanism 42 (second pulling means) described later.

The connection parts of the forward pulling mechanism 41 and the backward pulling mechanism 42 are merely examples and are not limited to those stated above. The pulling points of the forward pulling mechanism 41 and the backward pulling mechanism 42 may be provided in desired locations on the walking assistance apparatus 2. Further, the forward wire 34 and the backward wire 36 may not be attached to the walking assistance apparatus 2 and may be directly attached to the leg (paralyzed leg) on which the walking assistance apparatus 2 is mounted.

The lower thigh frame 23 is provided with a leg length variable mechanism 232 capable of adjusting the length of the walking assistance apparatus 2 in the leg length direction (the direction corresponding to the length of the user's leg). The leg length variable mechanism 232 is able to change the length of the walking assistance apparatus 2 in the leg length direction depending on the length of the user's leg. The leg length variable mechanism 232 may be installed in a desired location as long as it can adjust the length of the walking assistance apparatus 2 in the leg length direction.

The sole frame 25 is provided with a load sensor 252 that detects the load induced by the user's sole. It is possible to determine the user's walking state by the load value detected by the load sensor 252. Specifically, it is possible to determine the timing when the swing of the leg on which the walking assistance apparatus 2 is mounted is started. The motor unit 26 assists user's walking by rotationally driving the knee joint part 22 in accordance with the user's walking operation. The structure of the aforementioned walking assistance apparatus 2 is merely one example and it is not limited thereto. A desired walking assistance apparatus mounted on the leg part of the user and capable of assisting the user's walking may be employed.

The training apparatus 3 includes a treadmill 31 and a frame body 32. The control apparatus 100 may be embedded in the training apparatus 3. The treadmill 31 rotates a ring-shaped belt 311. The user stands on the belt 311, walks in accordance with the motion of the belt 311, to thereby perform the walking training.

The frame body 32 includes two pairs of column frames 321 which are installed on the treadmill 31, a pair of front and rear frames 322 which are connected to the respective column frames 321 and extend in the longitudinal direction, and three right and left frames 323 which are connected to the front and rear frames 322 and extend in the horizontal direction. The structure of the frame body 32 is not limited to the one described above. The frame body 32 may have any frame configuration as long as the forward pulling unit 35 and the backward pulling unit 37 can be appropriately fixed to the frame body 32.

The right and left frames 323 on the front side is provided with a forward pulling unit 35 which pulls the forward wire 34 upward and frontward. The forward wire 34 and the forward pulling unit 35 constitute the forward pulling mechanism 41. Further, the right and left frames 323 on the rear side is provided with a backward pulling unit 37 which pulls the backward wire 36 upward and rearward. The backward wire 36 and the backward pulling unit 37 constitute the backward pulling mechanism 42.

The forward pulling unit 35 includes, for example, a mechanism which winds and rewinds the forward wire 34, a motor which drives this mechanism, a mechanism which detects the length of the forward wire 34 pulled out from the forward pulling unit 35, and a mechanism which detects the angle of the forward wire 34. The mechanism which detects the angle of the forward wire 34 may detect the angle of the forward wire 34 with respect to the vertical direction. In a similar way, the backward pulling unit 37 includes, for example, a mechanism which winds and rewinds the backward wire 36, a motor which drives this mechanism, a mechanism which detects the length of backward wire 36 pulled out from the backward pulling unit 37, and a mechanism which detects the angle of the backward wire 36. The mechanism which detects the angle of the backward wire 36 may detect the angle of the backward wire 36 with respect to the vertical direction.

As described above, one end of each of the forward wire 34 and the backward wire 36 is connected to the walking assistance apparatus 2. The forward pulling unit 35 pulls the waling assistance apparatus 2 upward and frontward via the forward wire 34. The backward pulling unit 37 pulls the walking assistance apparatus 2 upward and rearward via the backward wire 36. The forward wire 34 and the backward wire 36 respectively extend upward and frontward and upward and rearward from the walking assistance apparatus 2 which is mounted on the leg part of the user. Accordingly, the forward wire 34 and the backward wire 36 do not interfere with the user during the user's walking and thus do not interrupt the walking training.

While the forward pulling unit 35 and the backward pulling unit 37 respectively control the pulling force of the forward wire 34 and the pulling force of the backward wire 36 by controlling drive torque of the motors, this structure is merely an example. A spring member may be connected to, for example, the forward wire 34 and the backward wire 36 and the pulling forces of the forward wire 34 and the backward wire 36 may be adjusted by adjusting an elastic force of the spring member.

The control apparatus 100 is one specific example of the control means. The structure of the control apparatus 100 will be described later. The control apparatus 100 controls the pulling forces of the forward pulling unit 35 and the backward pulling unit 37, the driving of the treadmill 31, and the operation of the walking assistance apparatus 2. Further, the control apparatus 100 is provided with a display unit 331 that displays information such as training instructions, training menu, training information (walking speed, biological information etc.) The display unit 331 is constituted, for example, as a touch panel and the user can input various kinds of information via the display unit 331.

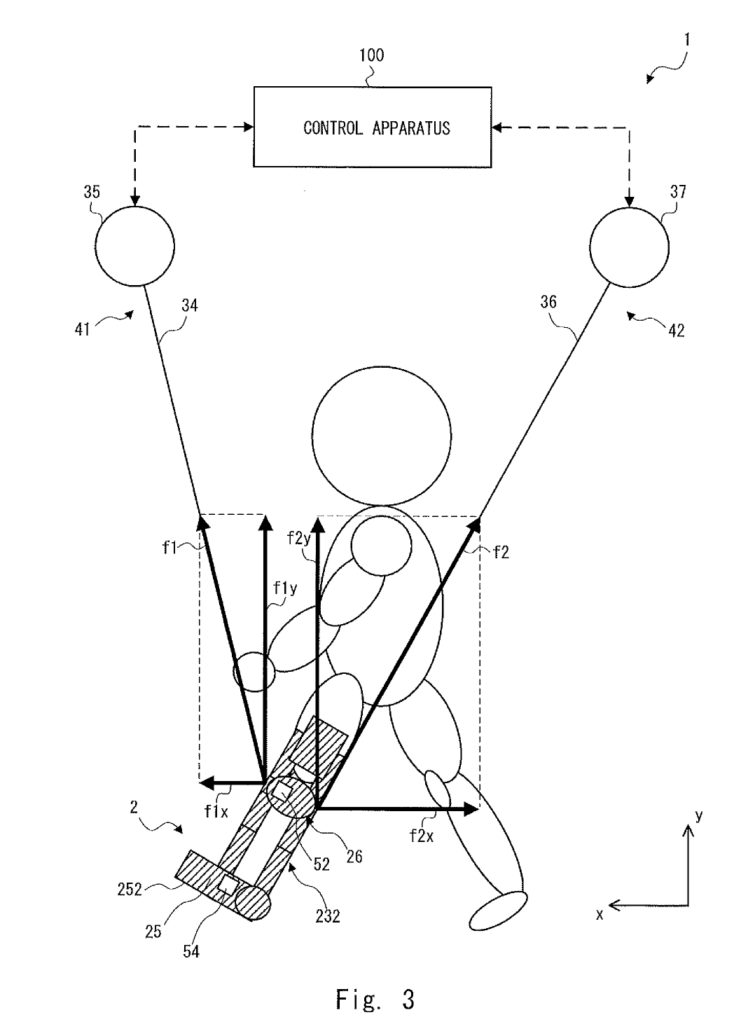

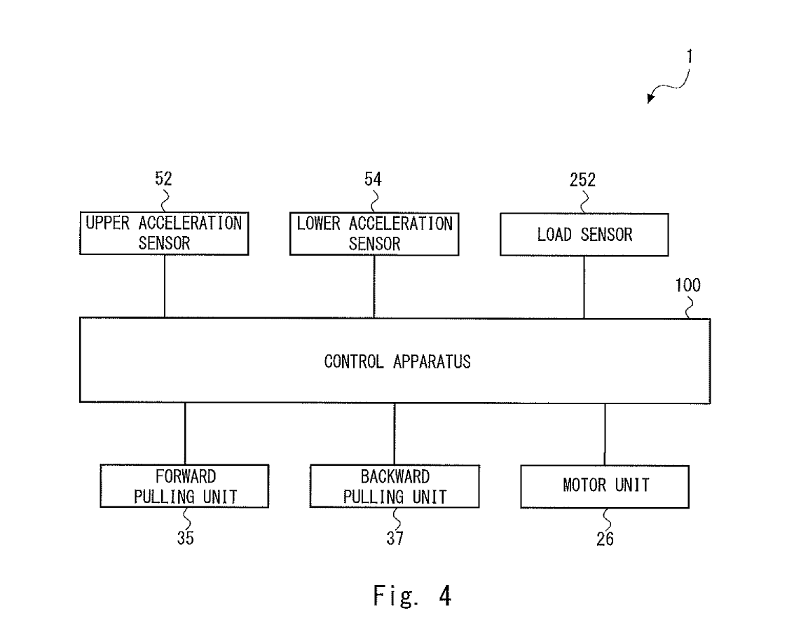

FIG. 3 is a diagram showing a schematic view of the walking training system 1 according to the first embodiment. FIG. 4 is a block diagram showing a hardware configuration of the walking training system 1 according to the first embodiment. As described above, the walking training system 1 includes the walking assistance apparatus 2, the forward pulling mechanism 41, the backward pulling mechanism 42, and the control apparatus 100. A coordinate system in which the forward direction in the walking training is the positive direction of the x axis and the vertical upward direction is the positive direction of the y axis is assumed.

The forward pulling mechanism 41 (forward pulling unit 35) pulls the walking assistance apparatus 2 upward and frontward at a pulling force f1. Further, the backward pulling mechanism 42 (backward pulling unit 37) pulls the walking assistance apparatus 2 upward and rearward at a pulling force f2. Accordingly, the weight of the walking assistance apparatus 2 is supported by a component in the vertically upward direction f1y of the pulling force f1 generated by the forward pulling mechanism 41 and a component in the vertically upward direction f2y of the pulling force f2 generated by the backward pulling mechanism 42. Further, the swing of the leg part is assisted by a component in the horizontal direction f1x of the pulling force f1 generated by the forward pulling mechanism 41 and a component in the horizontal direction f2x of the pulling force f2 generated by the backward pulling mechanism 42.

When the user wears the walking assistance apparatus 2 on his/her leg part and performs walking training, the walking load applied to the leg part may increase due to the weight of the walking assistance apparatus 2. On the other hand, the weight of the walking assistance apparatus 2 is supported and the swing of the leg part is assisted by using the walking training system 1 according to this embodiment, whereby it is possible to reduce the walking load of the user at the time of walking assistance.

The walking training system 1 further includes two acceleration sensors installed at locations on the walking assistance apparatus 2 spaced apart from each other in the leg length direction. In a location, on the walking assistance apparatus 2, upper than the leg length variable mechanism 232, an upper acceleration sensor 52 is installed, the upper acceleration sensor 52 being configured to detect the acceleration at the location where it is installed. While the upper acceleration sensor 52 is installed in the vicinity of the motor unit 26 (knee joint part 22) in the example shown in FIG. 3, this structure is merely an example. Further, in a location, on the walking assistance apparatus 2, lower than the leg length variable mechanism 232, a lower acceleration sensor 54 is installed, the lower acceleration sensor 54 being configured to detect the acceleration at the location where it is installed. While the lower acceleration sensor 54 is installed in the vicinity of the sole frame 25 in the example shown in FIG. 3, this structure is merely an example. As described above, since the leg length variable mechanism 232 is provided between the upper acceleration sensor 52 and the lower acceleration sensor 54, a sensor spacing D, which is the distance between the upper acceleration sensor 52 and the lower acceleration sensor 54, may be changed in accordance with the change in the length of the walking assistance apparatus 2 by the leg length variable mechanism 232.

As shown in FIG. 4, the control apparatus 100 is connected to the upper acceleration sensor 52, the lower acceleration sensor 54, the load sensor 252, the forward pulling unit 35, the backward pulling unit 37, and the motor unit 26 via a wired or wireless connection. The control apparatus 100 determines a timing of a bending motion of the knee from a load value detected by the load sensor 252 to control the bending motion of the motor unit 26. The motor unit 26 may determine a timing for rotationally driving the knee joint part 22 (timing of the bending motion of the knee) from the load value detected by the load sensor 252.

Specifically, for example, the control apparatus 100 may control the motor unit 26 to rotationally drive the knee joint part 22 and start the bending motion of the knee when the load value of the load sensor 252 becomes equal to or smaller than a predetermined threshold. Further, when the user's walking operation is substantially constant, the motion of the knee joint part 22 after the bending motion is started may be made constant in accordance with the elapsed time since the time when the bending motion has been started. Accordingly, for example, the control apparatus 100 may store a curve pattern indicating a relation between the elapsed time since the start of the bending motion and the target angle of the knee joint part 22 at this time (the rotation angle of the motor unit 26) in advance and control the rotation angle of the motor unit 26 (the bending motion of the knee joint part 22) in accordance with the curve pattern.

Further, the control apparatus 100 controls the forward pulling unit 35 and the backward pulling unit 37 in accordance with a force for supporting the weight of the walking assistance apparatus 2 (relief amount) and a force for assisting the swing (swing-assist amount) that have been set in advance. In this way, as described above, the pulling forces by the forward pulling mechanism 41 and the backward pulling mechanism 42 are controlled in such a way that the weight of the walking assistance apparatus 2 is supported and the swing of the leg part is assisted.

Further, the control apparatus 100 estimates, from the acceleration acquired by the upper acceleration sensor 52 and that acquired by the lower acceleration sensor 54, the acceleration at the location corresponding to the center of gravity of the walking assistance apparatus 2, that is, the acceleration at the center of gravity of the walking assistance apparatus 2. Then the control apparatus 100 calculates the inertia force acting on the walking assistance apparatus 2 from the product of the acceleration at the center of gravity (center-of-gravity acceleration) and the weight of the walking assistance apparatus 2. Then the control apparatus 100 performs, besides the control for reducing the walking load stated above, control of the forward pulling unit 35 and the backward pulling unit 37 in such a way as to reduce the inertia force acting on the walking assistance apparatus 2. Accordingly, the inertia force acting on the walking assistance apparatus 2 mounted on the leg part is reduced during the walking training, whereby the user is able to perform the walking training more efficiently. The details thereof will be described later.

The “center of gravity” of the walking assistance apparatus 2 includes not only the exact center of gravity of the walking assistance apparatus 2 but also the approximate center of gravity of the walking assistance apparatus 2. In the latter case, the center of gravity may be a predetermined location that is defined, by an operator or the like, to be the center of gravity of the walking assistance apparatus 2 in advance. Alternatively, the center of gravity (predetermined location) may be a predetermined location which is closer to the exact center of gravity of the walking assistance apparatus 2 with respect to the locations where the upper acceleration sensor 52 and the lower acceleration sensor 54 are installed and is within a predetermined range including the exact center of gravity. When the deviation between the exact center of gravity and the center of gravity (predetermined location) defined in advance or the predetermined range is large (wide), it is impossible to reduce the inertia force in such a way that the walking training becomes efficient for the user. Accordingly, the aforementioned deviation and the predetermined range are preferably small (narrow) enough to reduce the inertia force so that the walking training becomes efficient for the user.

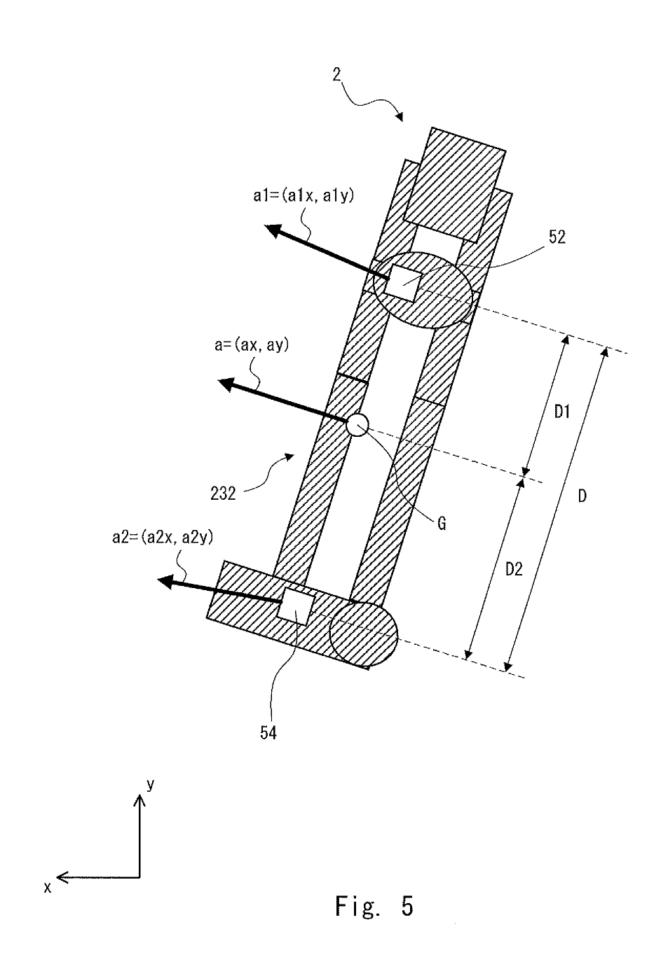

FIG. 5 is a diagram showing the walking assistance apparatus 2 and the acceleration sensors according to the first embodiment. The upper acceleration sensor 52 detects an acceleration a1 [m/s²] at the location where the upper acceleration sensor 52 is installed. Further, the lower acceleration sensor 54 detects an acceleration a2 [m/s²] at the location where the lower acceleration sensor 54 is installed. The acceleration a1 and the acceleration a2 are acceleration vectors, the components thereof being a1=(a1x,a1y) and a2=(a2x,a2y), respectively. Further, it is assumed that the center-of-gravity acceleration (acceleration vector), which is the acceleration at the center of gravity G of the walking assistance apparatus 2 (a predetermined location defined to be the center of gravity), is a=(ax,ay).

Further, the center of gravity G may be located between the upper acceleration sensor 52 and the lower acceleration sensor 54. In this embodiment, the center of gravity G is located on the line that connects the location where the upper acceleration sensor 52 is installed and the location where the lower acceleration sensor 54 is installed. The distance between the center of gravity G and the location where the upper acceleration sensor 52 is installed is denoted by D1[m] and the distance between the center of gravity G and the location where the lower acceleration sensor 54 is installed is denoted by D2[m]. In this case, D=D1+D2 is established. As described above, the sensor spacing D may be changed in accordance with the change in the length of the walking assistance apparatus 2 by the leg length variable mechanism 232. On the other hand, the center of gravity G may be uniquely defined in accordance with the change in the length of the walking assistance apparatus 2 by the leg length variable mechanism 232. That is, when the sensor spacing D is determined, the center of gravity G is uniquely defined. Accordingly, the distances D1 and D2 are changed in accordance with the change in the sensor spacing D and the distances D1 and D2 may be uniquely defined in accordance with the sensor spacing D.

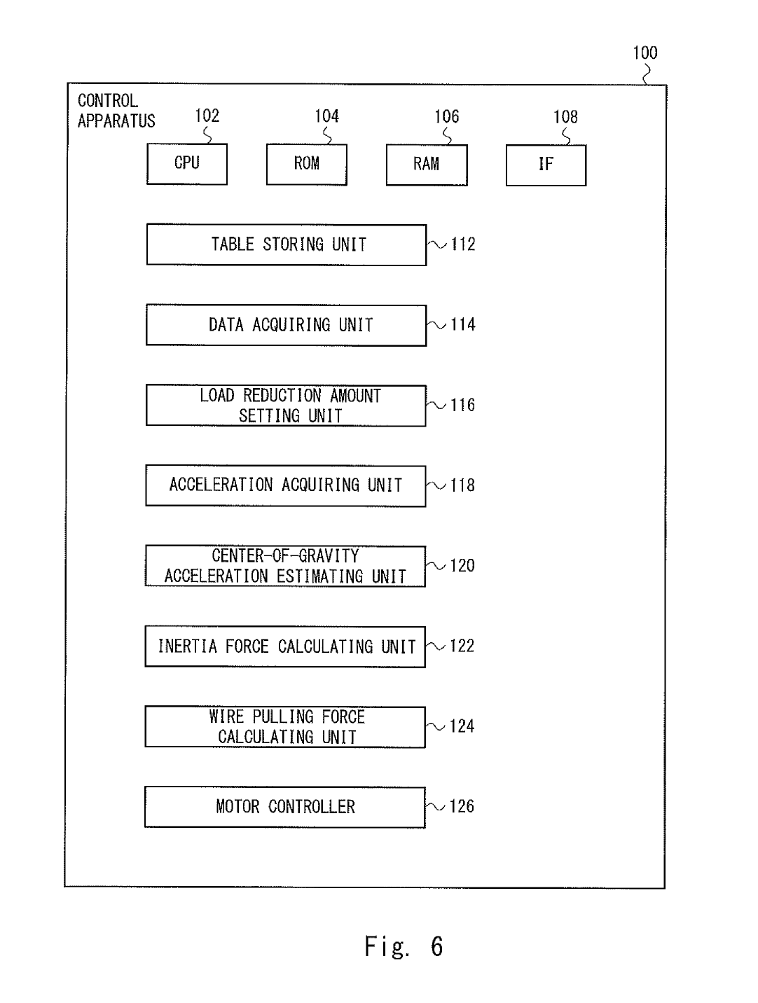

FIG. 6 is a block diagram showing a configuration of the control apparatus 100 according to the first embodiment. The control apparatus 100 includes, as main hardware configurations, a Central Processing Unit (CPU) 102, a Read Only Memory (ROM) 104, a Random Access Memory (RAM) 106, and an interface unit 108 (IF). The CPU 102, the ROM 104, the RAM 106, and the interface unit 108 are connected to one another via a data bus or the like.

The CPU 102 has a function as an operation apparatus that performs a control process, an operating process and the like. The ROM 104 has a function of storing a control program, an operation program and the like executed by the CPU 102. The RAM 106 has a function of temporarily storing processing data and the like. The interface unit 108 outputs/receives signals to/from external devices via a wired or wireless connection. Further, the interface unit 108 accepts operation of input of data by the user and displays information for the user. The aforementioned display unit 331 may be achieved by the interface unit 108.

Further, the control apparatus 100 includes a table storing unit 112, a data acquiring unit 114, a load reduction amount setting unit 116, an acceleration acquiring unit 118, a center-of-gravity acceleration estimating unit 120, an inertia force calculating unit 122, a wire pulling force calculating unit 124, and a motor controller 126 (hereinafter each of them is referred to as “each of the components”). The table storing unit 112, the data acquiring unit 114, the load reduction amount setting unit 116, the acceleration acquiring unit 118, the center-of-gravity acceleration estimating unit 120, the inertia force calculating unit 122, the wire pulling force calculating unit 124, and the motor controller 126 respectively have functions as the table storing means, the data acquiring means, the load reduction amount setting means, the acceleration acquiring means, the center-of-gravity acceleration estimating means, the inertia force calculating means, the wire pulling force calculating means, and the motor control means. Each of the components may be achieved by, for example, the CPU 102 executing the program stored in the ROM 104. Further, the necessary program may be stored in a desired non-volatile storage medium and installed as necessary. Each of the components is not limited to being achieved by software as stated above and may be achieved by any hardware such as a circuit element or the like.

The table storing unit 112 stores a table in which the sensor spacing D, the distance D1 between the center of gravity G and the upper acceleration sensor 52, and the distance D2 between the center of gravity G and the lower acceleration sensor 54 are associated with one another. This table may be generated in advance by gradually changing the sensor spacing D by the leg length variable mechanism 232, measuring the center of gravity G for each sensor spacing D, and measuring the distance between the center of gravity G that has been measured and the respective acceleration sensors (D1 and D2).

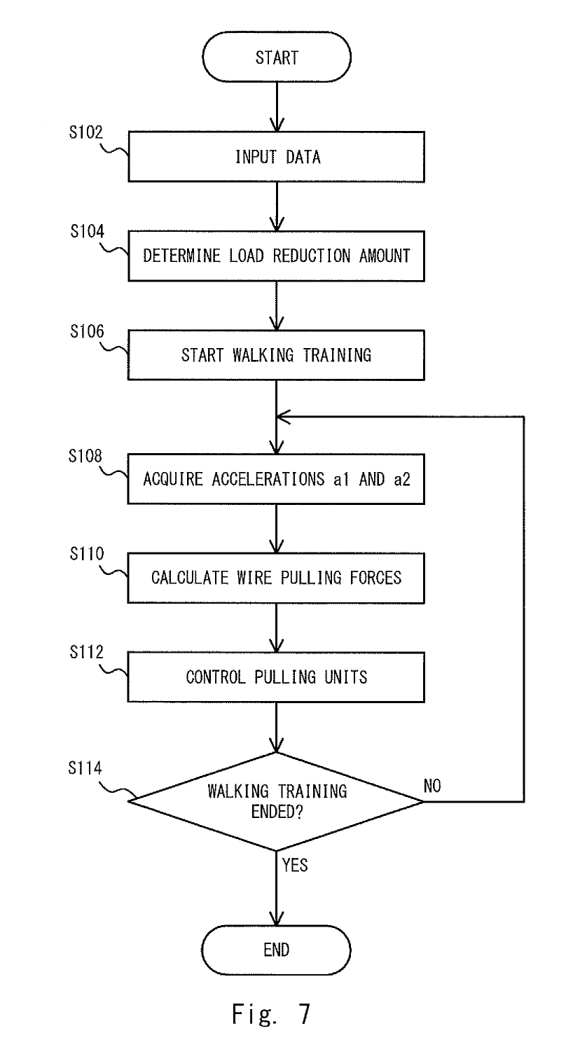

The functions of the components other than the table storing unit 112 will be described using the flowchart shown below (FIG. 7).

FIG. 7 is a flowchart showing a walking training method performed using the walking training system 1 according to the first embodiment. First, the operator inputs necessary data into the control apparatus 100 (Step S102). Specifically, the operator inputs data by operating the interface unit 108. The data acquiring unit 114 of the control apparatus 100 then accepts (i.e., receives) this data. The input data may include the weight m[kg] of the walking assistance apparatus 2. Further, the input data may include the sensor spacing D[m], which is a spacing between the upper acceleration sensor 52 and the lower acceleration sensor 54 when the walking assistance apparatus 2 is mounted on the leg part of the user. The leg length variable mechanism 232 adjusts the length of the walking assistance apparatus 2 in the leg length direction in such a way that it becomes longer as the length of the leg part of the user becomes longer. Accordingly, the sensor spacing D may vary depending on the length of the leg part of the user.

Next, the operator determines the load reduction amount using the control apparatus 100 (Step S104). Specifically, the operator operates the interface unit 108 to input the relief amount Fm[N] and the swing-assist amount Fa[N]. The load reduction amount setting unit 116 accepts (i.e., receives) the relief amount Fm and the swing-assist amount Fa that have been input and determines the relief amount Fm and the swing-assist amount Fa to be the load reduction amount used in the following process of calculating the wire pulling forces (S109). The relief amount Fm may be a value obtained by multiplying the weight m of the walking assistance apparatus 2 by the gravitational acceleration g[m/s²]. It is therefore possible to support the weight of the whole walking assistance apparatus 2 by the forward pulling mechanism 41 and the backward pulling mechanism 42.

Next, the walking training is started (Step S106). For example, when the operator operates a start switch provided in the control apparatus 100, the control apparatus 100 starts control for the walking training. When the walking training is started, the control apparatus 100 acquires, from the two acceleration sensors, the accelerations at the locations where the acceleration sensors are installed (Step S108). Specifically, the acceleration acquiring unit 118 acquires the acceleration a1 [m/s²] from the upper acceleration sensor 52 and acquires the acceleration a2 [m/s²] from the lower acceleration sensor 54.

Next, the control apparatus 100 calculates the wire pulling forces (Step S110). First, the center-of-gravity acceleration estimating unit 120 estimates a center-of-gravity acceleration a. Specifically, the center-of-gravity acceleration estimating unit 120 acquires the distances D1 and D2 corresponding to the sensor spacing D acquired by the data acquiring unit 114 using the table stored in the table storing unit 112. The center-of-gravity acceleration estimating unit 120 calculates the center-of-gravity acceleration a using the following Expression 1. Expression 1 may be independently calculated by the x and y components of the vector. In this way, the center-of-gravity acceleration a=(ax,ay) is calculated. The symbol “*” indicates multiplication.

a=(D2*a1+D1*a2)/(D1+D2) (Expression 1)

Next, the inertia force calculating unit 122 calculates an inertia force F[N] acting on the walking assistance apparatus 2. The inertia force F is a force vector, the component thereof being F=(Fx,Fy). The inertia force calculating unit 122 calculates the inertia force F using the following Expression 2.

Fx=−m*ax

Fy=−m*ay (Expression 2)

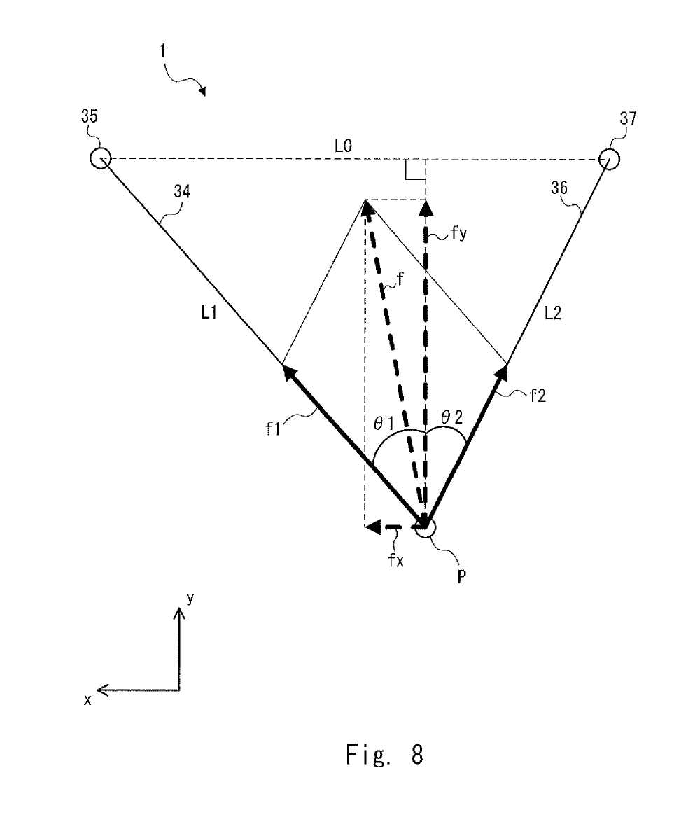

FIG. 8 is a diagram for describing a method of calculating the wire pulling forces. With reference to FIG. 8, the method of calculating the wire pulling forces will be described. It is assumed that the connection point in the walking assistance apparatus 2 of the forward wire 34 and that in the backward wire 36 coincide with each other at a point P. A triangle having vertices on the connection point P of the forward wire 34 and the backward wire 36 in the walking assistance apparatus 2, the forward pulling unit 35, and the backward pulling unit 37 is assumed. It is further assumed that the height of the forward pulling unit 35 is equal to the height of the backward pulling unit 37.

Further, the distance between the forward pulling unit 35 and the backward pulling unit 37 is denoted by L0[m] (hereinafter it will be referred to as a “motor spacing L0”). Further, the length, of the forward wire 34, that is pulled out from the forward pulling unit 35 is denoted by L1[m] (hereinafter it will be referred to as a “forward wire length L1”) and the length, of the backward wire 36, that is pulled out from the backward pulling unit 37 is denoted by L2[m] (hereinafter it will be referred to as a “backward wire length L2”). Further, the angle of the forward wire 34 with respect to the vertical direction is denoted by θ1 (hereinafter it will be referred to as a “forward wire angle θ1”) and the angle of the backward wire 36 with respect to the vertical direction is denoted by θ2 (hereinafter it will be referred to as a “backward wire angle θ2”).

The distance L0 is constant and is stored by the control apparatus 100 in advance. The forward wire length L1 and the forward wire angle θ1 can be detected by the forward pulling unit 35 as stated above. Accordingly, the control apparatus 100 is able to acquire the forward wire length L1 and the forward wire angle θ1 from the forward pulling unit 35. In a similar way, the backward wire length L2 and the backward wire angle θ2 can be detected by the backward pulling unit 37 and the control apparatus 100 is able to acquire the backward wire length L2 and the backward wire angle θ2 from the backward pulling unit 37.

The wire pulling force calculating unit 124 calculates the pulling forces of the forward wire 34 and the backward wire 36 in such a way as to reduce (cancel) the inertia force acting on the walking assistance apparatus 2. In other words, the wire pulling force calculating unit 124 calculates the pulling forces of the forward wire 34 and the backward wire 36 in such a way that a force equal to the inertia force F acts on the walking assistance apparatus 2 in the direction opposite to the direction of the inertia force F that has been calculated. Specifically, the wire pulling force calculating unit 124 first calculates, using the following Expression 3, a synthetic vector f[N] of a pulling force f1[N] of the forward wire 34 (hereinafter it will be referred to as a “forward wire pulling force f1”) and a pulling force f2[N] of the backward wire 36 (hereinafter it will be referred to as a “backward wire pulling force f2”). The synthetic vector f can be expressed by a component f=(fx,fy).

fx=−Fx+Fa

fy=−Fy+Fm (Expression 3)

Next, the wire pulling force calculating unit 124 calculates, from the synthetic vector f calculated using Expression 3, the pulling force f1 of the forward wire 34 and the pulling force f2 of the backward wire 36. The relation between the synthetic vector f=(fx,fy), and the forward wire pulling force f1 and the backward wire pulling force f2 can be expressed by the following Expression 4.

fx=f1*sinθ1−f2*sinθ2

fy=f1*cosθ1+f2*cosθ2 (Expression 4)

Further, the forward wire angle θ1 and the backward wire angle θ2 are calculated using the following Expression 5 using the motor spacing L0, the forward wire length L1, and the backward wire length L2.

L1*cosθ1=L2*cosθ2

L1*sinθ1+L2*sinθ2=L0 (Expression 5)

Accordingly, the wire pulling force calculating unit 124 can calculate f1 and f2 by calculating the forward wire angle θ1 and the backward wire angle θ2 using Expression 5 and substituting θ1 and θ2 that have been calculated into Expression 4.

Next, the control apparatus 100 controls the forward pulling unit 35 and the backward pulling unit 37 in such a way that they pull the wires at the wire pulling forces that have been calculated (Step S112). Specifically, the motor controller 126 controls the motor of the forward pulling unit 35 in such a way that the pulling force of the forward pulling unit 35 becomes f1. Accordingly, the forward pulling unit 35 pulls the forward wire 34 at the pulling force f1. Further, the motor controller 126 controls the motor of the backward pulling unit 37 in such a way that the pulling force of the backward pulling unit 37 becomes f2. Accordingly, the backward pulling unit 37 pulls the backward wire 36 at the pulling force f2.

Next, the control apparatus 100 determines whether the walking training has been ended (Step S114). Specifically, the control apparatus 100 determines, for example, whether a predetermined training time has expired. Alternatively, the control apparatus 100 may determine whether the operator has operated a stop switch. When it is determined that the walking training has been ended (YES in S114), the control apparatus 100 ends the walking training. On the other hand, when it is determined that the walking training has not been ended (NO in S114), the processes of S108-S112 are repeated.

As described above, the control apparatus 100 according to the first embodiment is able to control the wire pulling forces in order to reduce the inertia force acting on the walking assistance apparatus 2. Accordingly, it is possible to prevent a situation in which the user has difficulty in performing the walking operation due to the influence of the inertia force acting on the walking assistance apparatus 2 during the walking training. Accordingly, it is possible to perform more efficient walking training in the walking training system 1 according to the first embodiment compared to a case in which the inertia force acting on the walking assistance apparatus 2 is not reduced.

When the user starts swinging the leg (paralyzed leg) on which the walking assistance apparatus 2 is mounted and ends the swing of the paralyzed leg, in particular, a large inertia force may act on the walking assistance apparatus 2. Specifically, when starting the swing, the user tries to swing the paralyzed leg forward. However, it is difficult for the user to bring the paralyzed leg forward due to the backward inertia force acting on the walking assistance apparatus 2. Further, while the user tries to stop the paralyzed leg to end the swing, the paralyzed leg is brought excessively forward due to the forward inertia force acting on the walking assistance apparatus 2. Meanwhile, the walking training system 1 according to the aforementioned embodiment calculates the inertia force acting on the walking assistance apparatus 2 by estimating the acceleration at the center of gravity G of the walking assistance apparatus 2 and controls the wire pulling forces in such a way as to cancel the inertia force acting on the walking assistance apparatus 2. Accordingly, it is possible to prevent the situation in which the user has difficulty in bringing his/her paralyzed leg forward to start the swing and the situation in which the paralyzed leg is brought excessively forward to end the swing.

Even when the value of the inertia force acting on the walking assistance apparatus 2 is not calculated (estimated), it may be possible to increase the pulling force of the forward wire 34 by a predetermined value so that a forward force is applied when the swing is started and to increase the pulling force of the backward wire 36 by a predetermined value so that a backward force is applied when the swing is ended. However, this predetermined value does not include the inertia force that actually acts on the walking assistance apparatus 2. The inertia force that is actually acting on the walking assistance apparatus 2 may vary depending on the motion of the paralyzed leg, that is, the operation of the walking assistance apparatus 2. Therefore, it is possible that the inertia force may not be efficiently reduced by simply changing the pulling forces of the wires by a predetermined value when the swing is started and it is ended. On the other hand, the control apparatus 100 according to this embodiment calculates the inertia force acting on the walking assistance apparatus 2 by estimating the acceleration at the center of gravity G using the two acceleration sensors (the upper acceleration sensor 52 and the lower acceleration sensor 54). Accordingly, it is possible to reduce the inertia force more efficiently. That is, the user can perform the walking training as if he/she is not wearing the walking assistance apparatus 2. In other words, it is possible to perform the walking training by minimizing the influence due to the weight of the walking assistance apparatus 2 as much as possible.

If the acceleration sensor can be installed at the actual center of gravity of the walking assistance apparatus 2 in order to calculate the inertia force acting on the walking assistance apparatus 2, the upper acceleration sensor 52 and the lower acceleration sensor 54 may not be provided. However, depending on the structure of the walking assistance apparatus 2, it may be difficult to install the acceleration sensor at the actual center of gravity. Such a case includes, for example, a case in which there is no member for installing the acceleration sensor at the actual center of gravity.

Further, the length of the aforementioned walking assistance apparatus 2 in the leg length direction may be changed by the leg length variable mechanism 232 in accordance with the length of the leg part of the user. In this case, the actual center of gravity of the walking assistance apparatus 2 is changed in accordance with the change in the length of the walking assistance apparatus 2 in the leg length direction. Accordingly, in this case as well, it is difficult to install the acceleration sensor at the actual center of gravity. Although it may be possible to newly install the acceleration sensor each time the center of gravity is changed, it takes excessive time and trouble to newly install the acceleration sensor each time the length of the walking assistance apparatus 2 is changed.

On the other hand, the walking training system 1 according to this embodiment is able to calculate the inertia force acting on the walking assistance apparatus 2 even when the acceleration sensor is not installed at the center of gravity of the walking assistance apparatus 2. Accordingly, even when the acceleration sensor is not installed at the center of gravity of the walking assistance apparatus 2, the inertia force acting on the walking assistance apparatus 2 can be reduced. Accordingly, the walking training system 1 according to this embodiment is able to perform walking training more efficiently regardless of the structure of the walking assistance apparatus 2.

Further, since the walking training system 1 according to this embodiment is able to calculate the inertia force acting on the walking assistance apparatus 2 in accordance with the change in the length of the walking assistance apparatus 2 in the leg length direction, the walking training system 1 according to this embodiment is able to control the wire pulling forces in accordance with the change in the length of the walking assistance apparatus 2. Although it may be possible to newly install the acceleration sensor each time the center of gravity is changed, it takes excessive time and trouble to newly install the acceleration sensor each time the length of the walking assistance apparatus 2 is changed. On the other hand, in the walking training system 1 according to this embodiment, there is no need to newly install the acceleration sensor each time the length of the walking assistance apparatus 2 is changed.

### Second Embodiment

Next, a second embodiment will be described. The second embodiment is different from the first embodiment in that the number of wires is three. Since the other structures of the walking training system 1 according to the second embodiment are substantially similar to those of the walking training system 1 according to the first embodiment, descriptions thereof will be omitted.

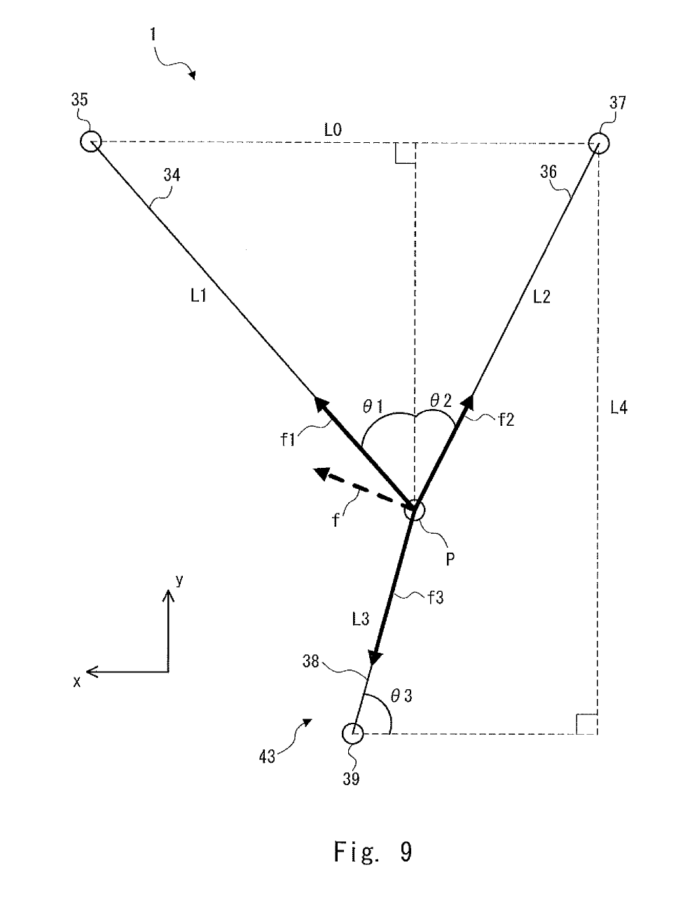

FIG. 9 is a diagram showing the walking training system 1 according to the second embodiment. In the example shown in FIG. 9, the walking training system 1 includes, besides the forward wire 34 and the backward wire 36, a lower wire 38 and includes, besides the forward pulling unit 35 and the backward pulling unit 37, a lower pulling unit 39. The lower wire 38 and the lower pulling unit 39 constitute a lower pulling mechanism 43 (third pulling means). The lower pulling unit 39 is provided, for example, in the treadmill 31. The lower pulling mechanism 43 (lower pulling unit 39) pulls the walking assistance apparatus 2 downward and frontward. The lower pulling mechanism 43 may pull the walking assistance apparatus 2 downward and rearward or may pull the walking assistance apparatus 2 downward (immediately below).

In the first embodiment, it is required that the synthetic vector f be directed to an inner side of the triangle having its vertices on the connection point P, the forward pulling unit 35, and the backward pulling unit 37, that is, in a direction between the direction of the forward wire 34 and the direction of the backward wire 36. In other words, in the configuration having only the forward pulling mechanism 41 and the backward pulling mechanism 42 like in the first embodiment, it is impossible to achieve the synthetic vector f which is directed to an outer side of the triangle having its vertices on the connection point P, the forward pulling unit 35, and the backward pulling unit 37, that is, in a direction deviated from the area between the direction of the forward wire 34 and the direction of the backward wire 36.

On the other hand, in the second embodiment, by providing the lower pulling mechanism 43 shown in FIG. 9, the synthetic vector f directed to a direction deviated from the area between the direction of the forward wire 34 and the direction of the backward wire 36 can be achieved. Accordingly, the walking training system 1 according to the second embodiment is able to achieve the synthetic vector f which is directed in a desired direction. In other words, in the walking training system 1 according to the second embodiment, the limitation of the direction of the synthetic vector of the pulling forces of the pulling means is suppressed. Accordingly, the degree of freedom of the method of reducing the burden on the user due to the wear of the walking assistance apparatus during the walking training such as a method of reducing the relief amount and increasing the swing-assist amount increases.

The lower wire 38 is connected to a desired location on the walking assistance apparatus 2. The lower pulling unit 39 includes, for example, a mechanism which winds and rewinds the lower wire 38, a motor which drives this mechanism, a mechanism which detects the length of the lower wire 38 pulled out from the lower pulling unit 39, and a mechanism which detects the angle of the lower wire 38. The mechanism which detects the angle of the lower wire 38 may detect an angle θ3 of the lower wire 38 (hereinafter it will be referred to as a “lower wire angle θ3”) with respect to the horizontal direction.

Further, in the example shown in FIG. 9, it is assumed that the connection point P of the forward wire 34, that of the backward wire 36, and that of the lower wire 38 in the walking assistance apparatus 2 coincide with each other. Further, the length of the lower wire 38 pulled out from the lower pulling unit 39 is denoted by L3[m] (hereinafter it will be referred to as a “lower wire length L3”). Further, the difference in height between the lower pulling unit 39 and the backward pulling unit 37 (forward pulling unit 35) is denoted by L4[m]. The difference in height L4 is constant and may be stored by the control apparatus 100 in advance. The lower wire length L3 and the lower wire angle θ3 can be detected by the lower pulling unit 39 as described above and the control apparatus 100 can acquire the lower wire length L3 and the lower wire angle θ3 from the lower pulling unit 39.

A method in which the wire pulling force calculating unit 124 calculates the pulling force of each of the wires (the forward wire 34, the backward wire 36, and the lower wire 38) in the example shown in FIG. 9 will be described. The method of calculating the center-of-gravity acceleration a and the inertia force F is similar to that in the first embodiment stated above.

The wire pulling force calculating unit 124 calculates, using Expression 3, the synthetic vector f[N] of the forward wire pulling force f1, the backward wire pulling force f2, and the pulling force f3 of the lower wire 38 (hereinafter it will be referred to as a “lower wire pulling force f3”). Next, the wire pulling force calculating unit 124 calculates, from the synthetic vector f, the forward wire pulling force f1, the backward wire pulling force f2, and the lower wire pulling force f3. The relation between the synthetic vector f=(fx,fy), and the forward wire pulling force f1, the backward wire pulling force f2, and the lower wire pulling force f3 is expressed by the following Expression 6.

fx=f1*sinθ1−f2*sinθ2+f3*cosθ3

fy=f1*cosθ1+f2*cosθ2−f3*sinθ3 (Expression 6)

Further, the forward wire angle θ1, the backward wire angle θ2, and the lower wire angle θ3 are calculated using the following Expression 7 that uses the motor spacing L0, the forward wire length L1, the backward wire length L2, the lower wire length L3, and the difference in height L4.

L1*cosθ1=L2*cosθ2

L1*sinθ1+L2*sinθ2=L0

L2*cosθ2+L3*sinθ3=L4 (Expression 7)

Accordingly, the wire pulling force calculating unit 124 is able to calculate f1, f2, and f3 by calculating the forward wire angle θ1, the backward wire angle θ2, and the lower wire angle θ3 using Expression 7 and then substituting the θ1, θ2, and θ3 that have been calculated into Expression 6.

### MODIFIED EXAMPLE

The present disclosure is not limited to the aforementioned embodiments and may be changed as appropriate without departing from the spirit of the present disclosure. For example, while the number of wires is two or three in the aforementioned embodiments, this structure is merely an example. The number of wires may either be one or four or larger as long as the inertia force acting on the walking assistance apparatus 2 can be reduced.

Further, while the operator inputs the sensor spacing D and the control apparatus 100 acquires the distances D1 and D2 using the table that has been stored in advance in the aforementioned embodiments, this structure is merely an example. It is sufficient that the distances D1 and D2 can be input and the operator may directly input the distances D1 and D2 without inputting the sensor spacing D.

Further, while the center-of-gravity acceleration estimating unit 120 acquires the distances D1 and D2 corresponding to the sensor spacing D using the table stored in the table storing unit 112 in the aforementioned embodiments, this structure is merely an example. There is no need to use the table as long as the distances D1 and D2 can be acquired. For example, the center of gravity in the longest sensor spacing D and that in the shortest sensor spacing D that can be adjusted by the leg length variable mechanism 232 may be measured and linear interpolation may be performed for the sensor spacing D between them, whereby the center of gravity may be estimated. Since the weight of the walking assistance apparatus 2 is not necessarily distributed symmetrically (evenly), it becomes possible to estimate the center-of-gravity acceleration more accurately by using the table.

Further, while the length of the walking assistance apparatus 2 in the leg length direction can be changed using the leg length variable mechanism 232 in the walking assistance apparatus 2 according to the aforementioned embodiments, this structure is merely an example. The walking assistance apparatus 2 may not include the leg length variable mechanism 232. As described above, even when the leg length variable mechanism 232 is not provided, in terms of the structure of the walking assistance apparatus 2, the acceleration sensor may not be installed at the center of gravity. As described above, the walking training system 1 according to this embodiment is still effective even when the walking assistance apparatus 2 does not include the leg length variable mechanism 232.

Further, in the walking training system 1 according to the aforementioned embodiments, the forward pulling unit 35 and the backward pulling unit 37 (and the lower pulling unit 39) are controlled in accordance with the relief amount and the swing-assist amount that have been set in advance in order to reduce the load of the walking assistance apparatus 2 applied to the leg part of the user. However, this structure of the walking training system 1 is merely an example. The control for reducing the load of the walking assistance apparatus 2 may be performed by only one of the relief amount and the swing-assist amount.

Further, the function for reducing the load of the walking assistance apparatus 2 may not be necessarily provided in the walking training system 1 according to this embodiment. The walking training system 1 may control the forward pulling unit 35 and the backward pulling unit 37 (and the lower pulling unit 39) only to reduce the inertia force acting on the walking assistance apparatus 2 during the walking training. However, the walking training system 1 has a function of reducing the load to thereby able to further reduce the burden on the user due to the wear of the walking assistance apparatus 2 during the walking training, whereby it is possible to perform the walking training further efficiently.

Further, while the control for reducing the inertia force is always performed during the walking training in the aforementioned embodiments, this structure is merely an example. The control for reducing the inertia force may not be always performed during the walking training. It is considered that, when the leg (paralyzed leg) on which the walking assistance apparatus 2 is mounted contacts the treadmill 31, there is little influence of the inertia force acting on the walking assistance apparatus 2. Therefore, the control for reducing the inertia force may be performed only when the paralyzed leg is in a lifted (i.e., swing) leg condition. The determination regarding whether the paralyzed leg is in the lifted leg condition may be performed using the load sensor 252. Specifically, the control apparatus 100 may determine that the paralyzed leg is in the lifted leg condition when the load value of the load sensor 252 becomes equal to or lower than a predetermined threshold (e.g., 0 [N]).

Furthermore, as described above, it is considered that a large inertia force may act on the walking assistance apparatus 2 when the swing of the paralyzed leg is started and it is ended. Accordingly, the control for reducing the inertia force (canceling the inertia force) may be performed only when the swing of the paralyzed leg is started and it is ended. More specifically, the control apparatus 100 may perform the control for reducing the inertia force only for a predetermined period of time including the timing when the swing of the paralyzed leg is started and for a predetermined period of time including the timing when the swing of the paralyzed leg is ended. As described above, by performing the control for reducing the inertia force only when it is estimated that a large inertia force acts, it is possible to separate the control for reducing the inertia force acting on the walking assistance apparatus 2 from the control for reducing the load of the walking assistance apparatus 2 applied to the paralyzed leg as much as possible. It is therefore possible to perform the control for reducing the load of the walking assistance apparatus 2 applied to the paralyzed leg more definitely in a period other than the timing when the swing of the paralyzed leg is started and the timing when it is ended, which are the timings when a large inertia force may act on the walking assistance apparatus 2.

The determination of the timing when the swing of the paralyzed leg is started and it is ended may be performed using the load sensor 252. Specifically, the control apparatus 100 may determine that the swing of the paralyzed leg has been started when the load value of the load sensor 252 becomes equal to or smaller than a predetermined threshold. The control apparatus 100 may determine that the swing of the paralyzed leg has been started when, for example, the paralyzed leg becomes away from the treadmill 31 and is in the lifted leg condition, that is, when the load value of the load sensor 252 becomes equal to or smaller than 0 [N]. Further, when the user performs a substantially constant walking operation, it is estimated that the swing of the paralyzed leg will end after a predetermined period of time since the swing of the paralyzed leg is started. Therefore, the control apparatus 100 may determine that the swing of the paralyzed leg has been ended after a predetermined period of time elapses since the start of the swing of the paralyzed leg. Further, since the start and the end of the swing may be determined in the aforementioned control of the bending motion of the knee joint part 22, the control apparatus 100 may determine the start and the end of the swing in conjunction with the control of the bending motion of the knee joint part 22. On the other hand, by performing the control for reducing the inertia force regardless of the state of swing of the paralyzed leg like in the walking training system 1 according to the aforementioned embodiments, it becomes unnecessary to determine the state of swing of the paralyzed leg. Accordingly, the control for reducing the inertia force may be simplified.

Further, while the center of gravity G is on the line that connects the location where the upper acceleration sensor 52 is installed and the location where the lower acceleration sensor 54 is installed in the aforementioned embodiments, the center of gravity G may not be strictly on the line that connects the location where the upper acceleration sensor 52 is installed and the location where the lower acceleration sensor 54 is installed. Since the walking assistance apparatus 2 has an elongated structure in the leg length direction, the center of gravity G does not deviate greatly from the line that connects the location where the upper acceleration sensor 52 is installed and the location where the lower acceleration sensor 54 is installed. Even when the center of gravity G is deviated from the line that connects the location where the upper acceleration sensor 52 is installed and the location where the lower acceleration sensor 54 is installed in the forward direction or the backward direction, it is estimated that the errors of the center-of-gravity acceleration a and the inertia force F that are calculated do not adversely affect the walking training for the user.

Further, while the load induced by the sole has been detected using the load sensor 252 in the aforementioned embodiments, this structure is merely an example. A force plate may be installed in the treadmill 31 and the load induced by the sole may be detected from the value of the force plate.

Further, while the walking training is performed by the user walking on the treadmill 31 in the aforementioned embodiments, this structure is merely an example. The walking training needs not be performed on the treadmill 31 as long as the pulling mechanisms can be moved in accordance with the movement by the user. On the other hand, the mechanisms that move the pulling mechanisms become unnecessary when the walking training is performed on the treadmill 31.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A walking training system used by a user for walking training, the walking training system comprising:
a walking assistance apparatus configured to be mounted on a leg part of the user and assist the user's walking;
two acceleration sensors installed at locations on the walking assistance apparatus spaced apart from each other in a leg length direction;
at least one pulling mechanism configured to pull at least one of the walking assistance apparatus and the leg part; and
a control apparatus configured to control a pulling force of the pulling mechanism,
wherein the control apparatus is configured to estimate, using a distance between a predetermined location corresponding to the center of gravity on the walking assistance apparatus and locations where the two acceleration sensors are installed and accelerations in the locations where the two acceleration sensors are installed acquired by the two acceleration sensors, an acceleration at the predetermined location, and control the pulling force to reduce an inertia force acting on the walking assistance apparatus calculated from the product of the estimated acceleration and the weight of the walking assistance apparatus.

2. The walking training system according to claim 1, wherein
the walking assistance apparatus comprises a leg length variable mechanism configured to vary the length of the walking assistance apparatus in the leg length direction, the spacing between the two acceleration sensors varying depending on the change in the length of the walking assistance apparatus in the leg length direction, and
the control apparatus is configured to acquire the distance that has been changed depending on the spacing between the two acceleration sensors that has been changed and control the pulling force using the acquired distance.

3. The walking training system according to claim 1, wherein
the pulling mechanism comprises:
a first pulling mechanism configured to pull at least one of the walking assistance apparatus and the leg part of the user upward and frontward; and
a second pulling mechanism configured to pull at least one of the walking assistance apparatus and the leg part of the user upward and rearward, and
the control apparatus is configured to control the pulling force of the first pulling mechanism and the pulling force of the second pulling mechanism in such a way as to reduce a load of the walking assistance apparatus applied to the leg part.

4. The walking training system according to claim 3, wherein
the pulling mechanism further comprises a third pulling mechanism configured to pull at least one of the walking assistance apparatus and the leg part of the user downward, and
the control apparatus is configured to control the pulling force of the first pulling mechanism, the pulling force of the second pulling mechanism, and the pulling force of the third pulling mechanism.

5. The walking training system according to claim 3, wherein the control apparatus is configured to determine a start and an end of swing of the leg part on which the walking assistance apparatus is mounted and control the pulling force in such a way as to reduce an inertia force acting on the walking assistance apparatus for a predetermined period of time including the timing when the leg part starts the swing and a predetermined period of time including the timing when the leg part ends the swing.
